(19) United States
(12) Patent Application Publication
(10) Pub. No.: US 2009/0214415 A1
(43) Pub. Date: Aug. 27, 2009

(54) System for generating oxygen using heat recycled from engine exhaust

(76) Inventors: Leon Emmanuel JEW, Pleasanton, CA (US); Sydney Furan HUANG, Pleasanton, CA (US)

Correspondence Address: LEON E. JEW, 5776 Stoneridge Mall Rd., Suite 288, Pleasanton, CA, 94588, US

(21) Appl. No.: 12/378,923

(22) Filed: Feb. 21, 2009

Related U.S. Application Data
(60) Provisional application No. 61/066,713, filed on Feb. 21, 2008.

(51) Int. Cl. B01J 19/00; C01B 13/00

(52) U.S. Cl. 423/579; 422/198

(57) ABSTRACT

A system for optimizing the quality of a vehicle's inner air includes an oxygen generator and an optimizer. The oxygen generator generates oxygen by dissociating water using recycled heat from the vehicle's exhaust. The optimizer automatically adjusts oxygen amount added into the vehicle's inner air according to the user's settings through an interface.

### REFERENCE TO RELATED APPLICATION

The present application claims priority to the provisional Appl. Ser. No. 61/066,713 filed on Feb. 21, 2008, the entire content of which is hereby incorporated by reference.

### FIELD OF THE INVENTION

The present invention relates generally to the method and apparatus for generating oxygen by thermal dissociation of water. More particularly, it relates to an oxygen generating system using heat recycled from engine exhaust of an vehicle.

### BACKGROUND OF THE INVENTION

There are various methods of generating oxygen, such as: (1) thermal decomposition of certain salts; (2) thermal decomposition of oxides of heavy metals; (3) thermal decomposition of peroxides; (4) electrolysis of water; and (5) fractional distillation of liquid air.

In the U.S. Pat. No. 4,030,890 and No. 4,071,608 Richard E. Diggs proposed an apparatus and method for separating hydrogen and oxygen from water molecules. A solar reflecting means reflects solar energy onto a water containing tank to boil water contained therein and form steam. The steam is transferred either to a turbine-generator assembly for producing power, or to a dissociating means for producing hydrogen and oxygen. The steam in the dissociating means is forced to traverse a spiral path wherein it undergoes a circular motion to subject it to centrifugal force while contacting a heat transfer surface. Solar energy is concentrated on the heat transfer surface and heat in amounts sufficient to raise the temperature of the steam to the dissociation temperature thereof is transferred thereto. Hydrogen and oxygen are separated from each other by the centrifugal forces, and are withdrawn from the dissociating means.

In the U.S. Pat. No. 4,053,576, Edward A. Fletcher proposed a system for producing and separating hydrogen and oxygen from water in which water is pumped through a preferentially permeable walled vessel heated to a high temperature by a solar energy concentrator. The water dissociates at high temperatures. Lower molecular weight components, especially hydrogen, diffuse preferentially through the vessel walls and are drawn off and separated. Oxygen may be separated from the products which do not diffuse through the walls by conventional separation techniques. A system is provided for making use of solar energy to produce storable fuels for use during periods of no sunshine.

In the U.S. Pat. No. 4,233,127, Daniel E. Monahan proposed a method and apparatus for generating hydrogen and oxygen gas from water with solar energy. A solar reflector concentrates solar energy into a water-containing reaction chamber to raise the temperature to the dissociation temperature of water. Both the thermal and photolytic effects of the sun's rays are employed to dissociate water. The hydrogen and oxygen formed upon dissociation are drawn off and separated.

In the U.S. Pat. No. 4,343,772, Robert A Frosch, et al, proposed a thermal reactor apparatus and method of pyrolyticaly decomposing silane gas into liquid silicon product and hydrogen by-product gas is disclosed. The thermal reactor has a reaction chamber which is heated well above the decomposition temperature of silane. An injecter probe introduces the silane gas tangentially into the reaction chamber to form a first, outer, forwardly moving vortex containing the liquid silicon product and a second, inner, rearwardly moving vortex containing the by-product hydrogen gas. The liquid silicon in the first outer vortex deposits onto the interior walls of the reaction chamber to form an equilibrium skull layer which flows to the forward or bottom end of the reaction chamber where it is removed. The by-product hydrogen gas in the second inner vortex is removed from the top or rear of the reaction chamber by a vortex finder. The injecter probe which introduces the silane gas into the reaction chamber is continually cooled by a cooling jacket having water circulating therethrough to keep the temperature of the silane gas well below its decomposition temperature prior to being introduced into the reaction zone.

In the U.S. Pat. No. 5,397,559, Abraham Kogan proposed a method for the separate recovery of a high molecular weight gas and a low molecular weight gas from a gaseous starting mixture in which they are contained, comprising steps of: providing first, second and third chambers arranged in series and separated from each other by membranes permeable preferentially to the low molecular weight gas; charging the first chamber with the gaseous starting mixture; withdrawing from the first chamber a first product gaseous mixture enriched with the high molecular weight gas; withdrawing from the second chamber a second product gaseous mixture and recycling it into the first chamber; withdrawing from the third chamber a third product gaseous mixture enriched with the low molecular weight gas; subjecting the first and third product gaseous mixtures separately to treatment by which undesired gaseous components are rendered non-gaseous; and separately recovering the remaining low molecular and high molecular weight gases.

In the U.S. Pat. No. 6,521,205, J. Thomas Beck proposed a process and an apparatus for producing hydrogen from water, including the steps of heating water to a water dissociating temperature to form a dissociated water reaction mixture comprising hydrogen gas and oxygen gas. A vortex is formed of the reaction mixture to subject the reaction mixture to a centrifugal force about a longitudinal axis of an interior space of a vortex tube reactor, so that there is radial stratification of the hydrogen gas and the oxygen gas in the interior space of the vortex tube reactor. Hydrogen or oxygen is preferentially extracted from the reaction mixture at spaced apart points along the length of the interior space of the vortex tube reactor.

None of the existing arts suggests an apparatus or method for generating oxygen using the heat recycled from the exhaust of a vehicle's engine. A large amount of heat from automobiles is wasted. The heat can be recycled and used in generating oxygen and hydrogen from water without using additional energy. Therefore, there is a need for alternative method and apparatus for generating oxygen by thermal dissociation of water using heat recycled from engine exhaust.

### SUMMARY OF THE INVENTION

The present invention teaches a system for optimizing the quality of a vehicle's inner air using gaseous oxygen which is generated using recycled heat from the vehicle's exhaust. The system comprises an oxygen generator, which generates oxygen by decomposing water using recycled heat from the vehicle's exhaust; and an optimizer, which automatically adjusts oxygen amount added into the vehicle's inner air. In one preferred embodiment, the oxygen generator is mechanically coupled between the vehicle's engine and the vehicle's muffler. In the second preferred embodiment, the oxygen generator is mechanically coupled with the vehicle's muffler.

The oxygen generator comprises: a first means to transform water into steam; a second means to transform the steam into gas comprising gaseous oxygen and gaseous hydrogen; and a third means to extract the gaseous oxygen from the gas. The second means comprises at least one path through which the steam passes from the first means into the third means. The at least one path's inner surface is coated with a catalyst which catalyzes dissociation of water molecules into gaseous oxygen and gaseous hydrogen. The second means comprises at least one honeycomb-like structure which is replaceable. The honeycomb-like structure has a number of paths, i.e. pass-through holes. Each path's inner surface is coated with a catalyst which catalyzes dissociation of water molecules into gaseous oxygen and gaseous hydrogen.

The optimizer comprises an array of sensors for collecting data related to the quality of the vehicle's inner air, an adjustor for adjusting the amount of input oxygen to be added into the vehicle's inner air, and a controller coupled to the adjuster and to a processor.

The processor is associated with a database and a tablet interface. Through the tablet interface, the user may give operational command for initiating or setting the air optimization parameters.

### BRIEF DESCRIPTION OF DRAWINGS

FIG. 1 is a high level schematic block diagram illustrating the process according to the invention;

FIG. 2 is a schematic diagram illustrating an oxygen generating system according to one preferred embodiment, in which a splitter is mechanically coupled between the engine's exhaust outlet and the vehicle's muffler;

FIG. 3 is a schematic diagram illustrating an oxygen generating system according to another preferred embodiment, in which a splitter and a muffler are combined in one mechanical unit;

FIG. 4 is a schematic diagram illustrating the splitter according to the embodiment as illustrated in FIG. 2;

FIG. 5A is a schematic diagram illustrating the side sectional view of an inner structure of the decomposition chamber as illustrated in FIG. 4;

FIG. 5B is a schematic diagram illustrating the cross sectional view of an inner structure of the decomposition chamber as illustrated in FIG. 4;

FIG. 6 is a schematic diagram illustrating a cross-sectional view of a decomposition chamber according to another embodiment;

FIG. 7A is a schematic diagram illustrating the cross sectional view of the catalyst structure which is installed in the round holes of the frame of the decomposition chamber as illustrated in FIG. 6;

FIG. 7B is a schematic diagram illustrating the side sectional view of the catalyst structure which is installed in the round holes of the frame of the decomposition chamber as illustrated in FIG. 6;

FIG. 8 is a schematic diagram illustrating a cross-sectional view of a 42-channel decomposition chamber according to another embodiment;

FIG. 9A is a schematic diagram illustrating the cross sectional view of the catalyst structure which is installed in the regular hexagonal passing-through holes of the frame of the decomposition chamber as illustrated in FIG. 8;

FIG. 9B is a schematic diagram illustrating the side sectional view of the catalyst structure which is installed in the regular hexagonal passing-through holes of the frame of the decomposition chamber as illustrated in FIG. 8;

FIG. 10 is a schematic diagram illustrating a cross-sectional view of a 342-channel decomposition chamber according to another embodiment;

FIG. 11A is a schematic diagram illustrating the cross sectional view of the catalyst structure which is installed in the eighteen regular hexagonal passing-through holes of the honeycomb-like frame of the decomposition chamber as illustrated in FIG. 10;

FIG. 11B is a schematic diagram illustrating the side sectional view of the catalyst structure which is installed in the eighteen regular hexagonal passing-through holes of the honeycomb-like frame of the decomposition chamber as illustrated in FIG. 10;

FIG. 12 is a schematic block diagram illustrating the process of the oxygen extraction;

FIG. 13 is a schematic block diagram illustrating the process of the oxygen extraction according to another embodiment;

FIG. 14 is a schematic block diagram illustrating the process of the oxygen extraction according to another embodiment;

FIG. 15 is a schematic block diagram illustrating the principle of adjusting quality parameters of the air in an enclosure such as the interior of a vehicle;

FIG. 16 is a schematic block diagram illustrating a vehicle air optimization system according to the principle as illustrated in FIG. 15;

FIG. 17 is a schematic diagram illustrating the first see-and-touch screen, i.e., the “Main Menu” or “Home” of the interface;

FIG. 18 is a schematic diagram illustrating the “Automatic Optimization” screen;

FIG. 19 is a schematic diagram illustrating the “Manual Optimization” screen;

FIG. 20 is a schematic diagram illustrating the “Favorite Setting” screen;

FIG. 21 is a schematic diagram illustrating a screen when the “Save It” icon is touched;

FIG. 22 is a schematic diagram illustrating a screen when the “Saved Settings” icon is touched;

FIG. 23 is a schematic diagram illustrating the “Natural Air” screen; and

FIG. 24 is a schematic diagram illustrating the “Off” screen.

### DESCRIPTION OF THE INVENTION

The spirit of this invention is first to decompose water using heat recycled from a vehicle's exhaust system, and second to extract gaseous oxygen from the post-decomposition gas, and third to use the gaseous oxygen to optimize the quality of the air inside the vehicle.

The system according to the invention provides the driver and passengers with an optimized oxygen bar experience after the vehicle is started without consuming additional resources other than water. With reference to the schematic drawings, the invention is now described in detail with regard for the best mode and the preferred embodiments.

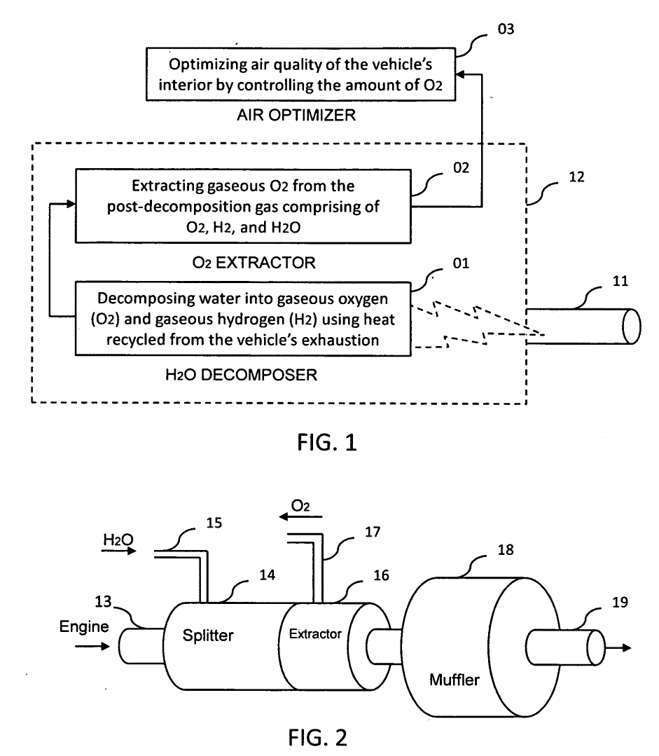

FIG. 1 is a high level schematic block diagram illustrating the process according to the invention. The process includes three basic steps. The first step, i.e., Step 01, is to dissociate or decompose water (H₂O) into gaseous oxygen (O₂) and gaseous hydrogen (H₂) using heat recycled from the exhaust outlet 11 of a vehicle's engine. The second step, i.e., Step 02, is to extract gaseous oxygen (O₂) from the gas generated from the decomposition reaction. The third step, i.e., Step 03, is to optimize the quality of the air in the interior of the vehicle by distributing appropriate amount of oxygen (O₂) into the air. Step 01 and Step 02, together, constitute the function of an oxygen generating system 12, which is further described below.

### The Oxygen Generation Using Recycled Heat

The oxygen generating process according to the invention includes a process of heat dissociation and a process of oxygen extraction. Accordingly, the oxygen generator according to the invention includes a splitter, which uses heat to catalyze the chemical reaction to generate gaseous oxygen (O₂), and an extractor, which extracts gaseous oxygen (O₂) from the gas generated from the chemical reaction. In this document, “splitter” and “decomposer” are synonyms and are used interchangeably. The chemical reaction to generate oxygen can be a chemical dissociation or decomposition, such as splitting water molecules into gaseous oxygen (O₂) and gaseous hydrogen (H₂) as represented by the formula (1):

2H₂O→2H₂+O₂ (1)

### The Decomposition of Water

The chemical decomposition, or the splitting, requires a large amount of heat. For the purpose of recycling heat, the splitter according to the invention is incorporated with a source of waste heat such as the exhaust system of a combustion engine.

FIG. 2 is a schematic diagram illustrating the oxygen generating system according to one preferred embodiment, in which the splitter 14 is mechanically coupled between the engine's exhaust outlet 13 and the vehicle's muffler 18. The heat carried by the exhaust gas from the engine is recycled and utilized to catalyze the chemical decomposition in the splitter 14. The splitter 14 has an inlet 15, from which the water is added. The splitter is coupled to the extractor 16. A few minutes after the engine is started, the temperature at the engine's exhaust outlet can be as high as 1000 C degrees or higher, a controlled amount of water (H₂O) is injected from the inlet 16 into the splitter 14. In the splitter 14, due to the increasing amount of heat from the engine's exhaust, the water is instantly vaporized and transformed into hot steam. Because of the high temperature, the hot steam is forced to pass through a catalyst structure. While passing through the catalyst structure, water molecules are decomposed into gaseous oxygen (O₂) and gaseous hydrogen (H₂). Because the water molecules are not 100% decomposed, the post-decomposition gas may include gaseous oxygen (O₂), gaseous hydrogen (H₂), and water molecules (H₂O). Gaseous oxygen (O₂) is extracted by the extractor 16 and transported through the outlet 17 to the air optimizer. The advantage of this embodiment is that the oxygen generating system can be installed without changing the vehicle's muffler and the exhaust system.

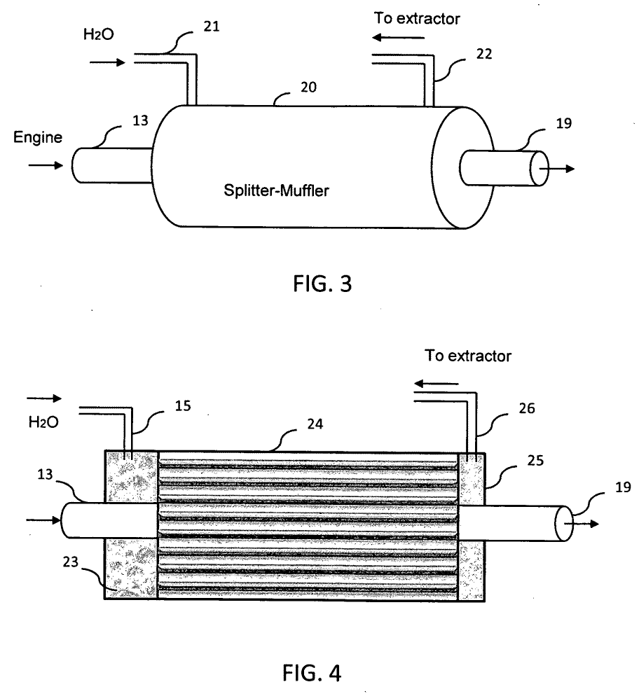

FIG. 3 is a schematic diagram illustrating the oxygen generating system according to another preferred embodiment, in which a splitter and a muffler are combined in one mechanical unit 20. The heat carried by the exhaust gas from the engine is recycled and utilized to catalyze the chemical decomposition in the splitter integrated with the muffler. The mechanical unit 20 has an inlet 21, from which a controlled stream of water is added, and outlet 22, from which the post-decomposition gas is transported to an extractor. A few minutes after the engine is started, the temperature at the muffler can be as high as 1000 C degrees or higher, a controlled stream of water (H₂O) is injected from the inlet 21 into the splitter in the unit 20. In the splitter, due to the increasing amount of heat from the engine's exhaust, the water is instantly transformed into hot steam, and the hot steam, while passing through a catalyst structure, is decomposed into gaseous oxygen (O₂) and gaseous hydrogen (H₂). Since the water molecules are not all decomposed, the output gas from the outlet 22 may include gaseous oxygen (O₂), gaseous hydrogen (H₂), and water molecules (H₂O). The post-decomposition gas is transported to an extractor where the gaseous oxygen (O₂) is separated from gaseous hydrogen (H₂) and water molecules (H₂O).

Yet in another embodiment, the splitter, the extractor, and the muffler can be integrated in a “three-in-one” mechanical unit. In that case, the input is water and the output is gaseous oxygen and hydrogen. The “three-in-one” mechanical unit performs functions of noise attenuation, decomposition of water, and extraction of gaseous oxygen and hydrogen. In the design of next generation vehicles, the traditional muffler will be replaced by the “three-in-one” mechanical unit.

FIG. 4 is a schematic diagram illustrating the splitter according to the embodiment as illustrated in FIG. 2. For the purpose of illustration simplicity, the extractor is not included in FIG. 4. The splitter includes a first small chamber 23 where water is vaporized and transformed into hot steam, a second chamber 24 where the hot steam is decomposed into gaseous oxygen (O₂) and gaseous hydrogen (H₂), and a third chamber 25 where the post-decomposition gas from the second chamber temporarily stays before exiting from the outlet 26 to an extractor. The second chamber 24 includes a number of small paths which connect the first chamber 23 and the third chamber 25. The inner surface of the small paths is coated with heat-resistant catalyst. When the hot steam is forced to pass through the small paths in the second chamber 24, most of the water molecules are decomposed into gaseous oxygen (O₂) and gaseous hydrogen (H₂). The pipe for the engine's exhaust passes through the splitter along its central axis. The first end 13 of the pipe enters the first chamber 23 and its second end 19 exits from the third chamber 25. The heat carried by the exhaust gas is conducted to the chambers of the splitter and it is recycled while the water is vaporized in the first chamber 23 and decomposed in the second chamber 24, and while the post-decomposition gas in the third chamber 25 is forced to exit through the outlet 26. The outlet 26 is coupled to the extractor where the gaseous oxygen (O₂) is separated from gaseous hydrogen (H₂) and water molecules (H₂O). Note that the metal pipe for the engine's exhaust goes through the chambers but the engine's exhaust will never meets the water, the hot steam, or gaseous oxygen (O₂) and gaseous hydrogen (H₂) in the chambers.

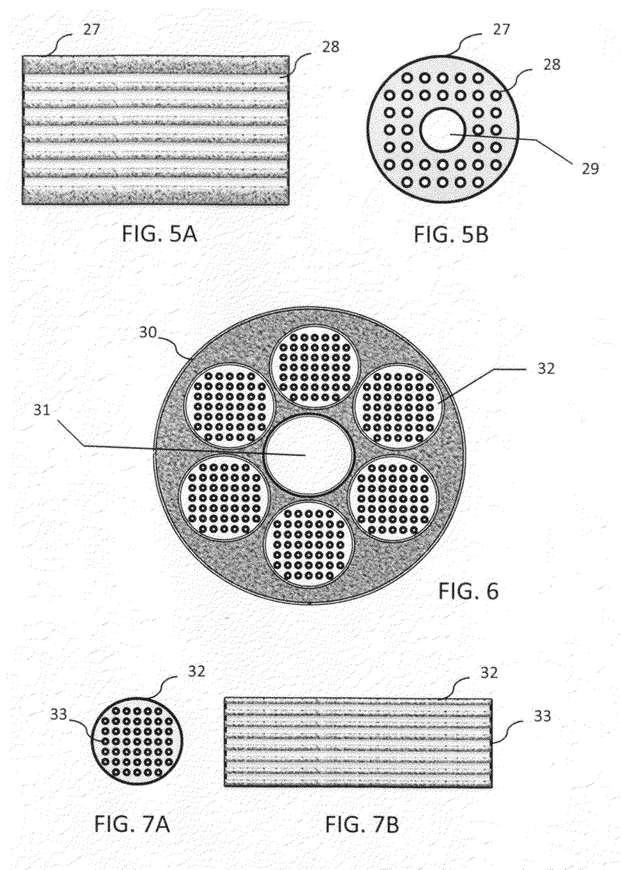

FIG. 5A and FIG. 5B are schematic diagrams illustrating the side sectional view and cross sectional view, respectively, of an inner structure of the decomposition chamber as illustrated in FIG. 4. The structure includes a metal body 27, a number of small paths 28, and a central path 29 which is coupled to the engine's exhaust pipe. The hot steam from the vaporization chamber is forced to travel through the small paths, which are passing-through tubes. The inner surface of the small paths is coated with catalyst for decomposing or dissociating water molecules. The heat carried by the exhaust from the vehicle's engine is conducted to the metal body 27 through the vehicle's exhaust pipe and then to the hot steam through the metal body 27. Under the high temperature and the influence of the catalyst, the chemical bonds between the oxygen atom and the hydrogen atoms break, and two oxygen atoms are further combined into one molecule of gaseous oxygen. The dissociation temperature of water varies depending on the type of catalyst.

FIG. 6 is a schematic diagram illustrating a cross-sectional view of a decomposition chamber according to another embodiment. The decomposition chamber includes a frame 30 with a central path 31 for the vehicle's exhaust pipe. There are six round holes which are evenly spread around the central path 31. Each of the holes is used to hold a catalyst structure 32 which is removable and replaceable.

FIG. 7A and FIG. 7B are schematic diagrams illustrating the cross sectional view and the side sectional view, respectively, of the catalyst structure which is installed in the round holes of the frame of the decomposition chamber as illustrated in FIG. 6. There are a number of passing-through holes 33 in each of the catalyst structure 32. In operation, the hot steam travels through the passing-through holes 33 and is decomposed or dissociated therein.

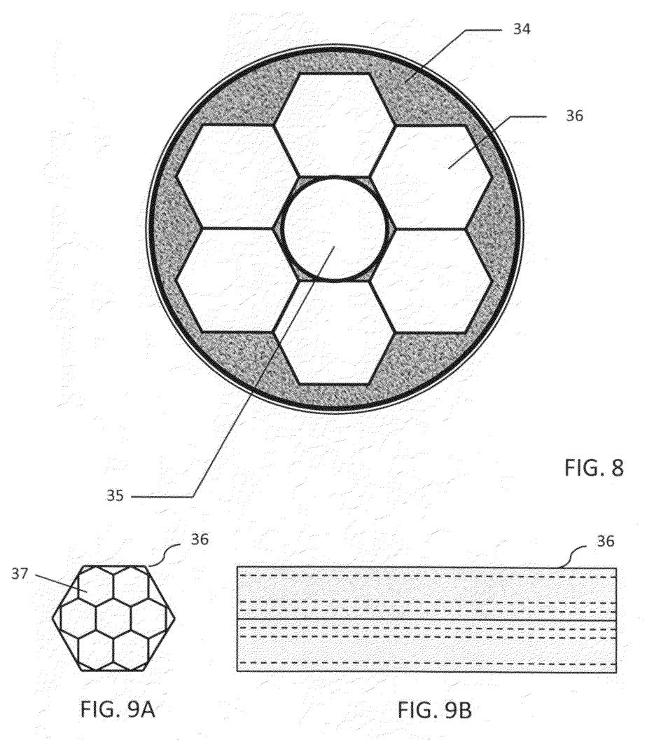

FIG. 8 is a schematic diagram illustrating a cross-sectional view of a 42-channel decomposition chamber according to another embodiment. The decomposition chamber includes a frame 34 with a central path 35 for the vehicle's exhaust pipe. There are six regular hexagonal passing-through holes which are evenly spread around the central path 35. Each of the regular hexagonal passing-through holes is used to hold a catalyst structure which is removable and replaceable. Each of the catalyst structure has seven passing-through holes. The passing-through holes can be hexagonal in shape, as illustrated, or any other regular or irregular shape, and or of same or different sizes. There can be any number of passing-through holes in the hexagon structure or structure of any other shape.

FIG. 9A and FIG. 9B are schematic diagrams illustrating the cross sectional view and the side sectional view, respectively, of the catalyst structure which is installed in the regular hexagonal passing-through holes of the frame of the decomposition chamber as illustrated in FIG. 8. There are seven regular hexagonal passing-through holes 37 in each of the catalyst structure 36. In operation, the hot steam travels through forty two passing-through holes (6 times 7) and is decomposed therein. The passing through-holes 37 can be hexagonal in shape, as illustrated, or any other regular or irregular shape, and or of same or different sizes. There can be any number of passing-through holes in the hexagon structure or structure of any other shape.

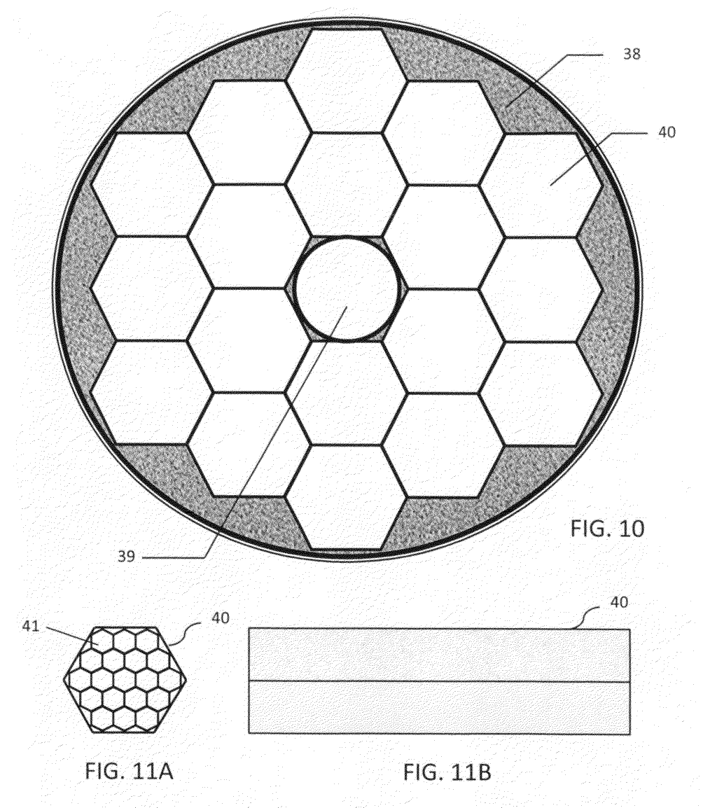

FIG. 10 is a schematic diagram illustrating a cross-sectional view of a 342-channel decomposition chamber according to another embodiment. The decomposition chamber includes a honeycomb-like frame 38 with a central path 39 for the vehicle's exhaust pipe. There are eighteen regular hexagonal passing-through holes which are evenly spread around the central path 39. Each of the regular hexagonal passing-through holes is used to hold a catalyst structure 40 which is removable and replaceable. The passing through-holes can be honeycomb-like in shape, as illustrated, or any other regular or irregular shape, and or of same or different sizes. There can be any number of passing-through holes in the hexagon structure or structure of any other shape.

FIG. 11A and FIG. 11B are schematic diagrams illustrating the cross sectional view and the side sectional view, respectively, of the catalyst structure which is installed in the eighteen regular hexagonal passing-through holes of the honeycomb-like frame of the decomposition chamber as illustrated in FIG. 10. There are nineteen regular hexagonal passing-through holes 41 in each of the catalyst structure 40. In operation, the hot steam travels through 342 passing-through holes (18 times 19) and is decomposed therein.

The passing through-holes can be honeycomb-like in shape, as illustrated, or any other regular or irregular shape, and or of same or different sizes. There can be any number of passing-through holes in the hexagon structure or structure of any other shape.

### The Extraction of Gaseous Oxygen

The extractor can be integrated with the splitter as illustrated in FIG. 2. It can also be in a separate body connected to the splitter through a pipe.

There are two basic types of extractors. One is to extract gaseous oxygen from the post-decomposition gas and discharge the rest to the outside air. The other is to extract hydrogen from the post-decomposition gas and use the rest for air optimization inside the vehicle.

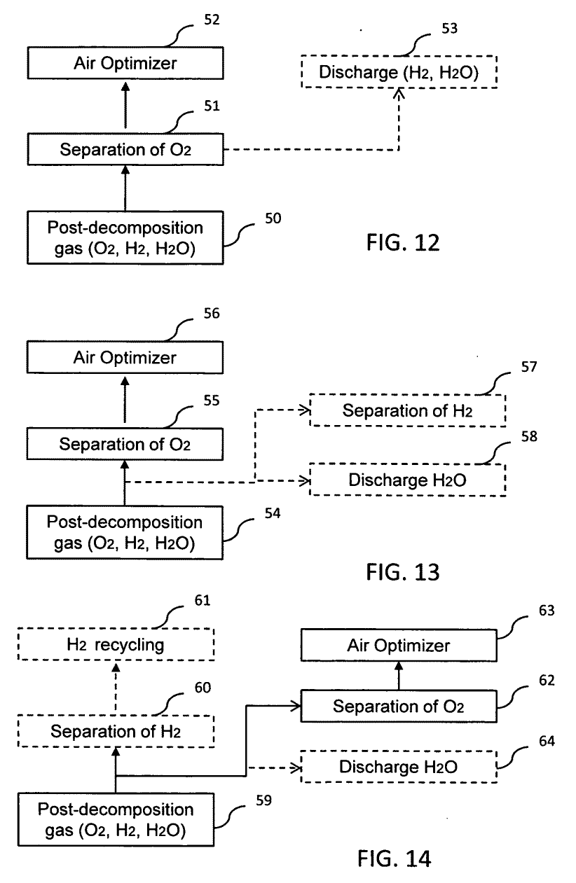

FIG. 12 is a schematic block diagram illustrating the process of the oxygen extraction. The post-decomposition gas 50 from the splitter is processed. The oxygen is first separated 51 from the rest and conveyed to the air optimizing system 52. The rest of the gas including hydrogen and small amount of water molecules is discharged into the outside air.

FIG. 13 is a schematic block diagram illustrating the process of the oxygen extraction according to another embodiment. The post-decomposition gas 54 from the splitter is processed. The oxygen is first separated 55 from the rest and conveyed to the air optimizing system 56. Then, the hydrogen is separated 57 and the remnant water molecules are discharged into the outside air. The separated hydrogen may be further recycled. As an example, it can be mixed with the gasoline as the vehicle's fuel.

FIG. 14 is a schematic block diagram illustrating the process of the oxygen extraction according to another embodiment. The post-decomposition gas 59 from the splitter is processed. The hydrogen is first separated 60 from the rest and conveyed to a hydrogen recycling system 61. As an example, the hydrogen can be mixed with the gasoline as the vehicle's fuel. Then, the oxygen is separated 62 and conveyed to the air optimizing system 63. The remnant water molecules are discharged into the outside air 64.

### Computerized Air Optimization

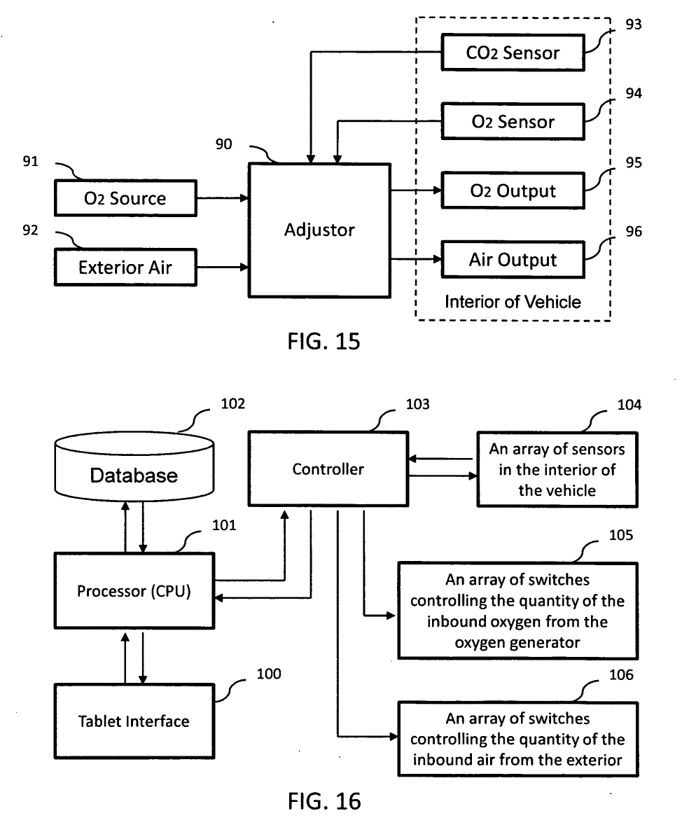

FIG. 15 is a schematic block diagram illustrating the principle of adjusting quality parameters of the air in an enclosure such as the interior of a vehicle. As an example, the adjustor 90 is a computerized controlling unit which adjusts the amount of oxygen inputted into the enclosure and the amount of exterior air inputted into the enclosure according to the feedback from the sensors installed in the enclosure. The sensors are used to collect data relevant to the quality of the air of the vehicle's interior. The adjustor 90 is coupled to the oxygen source 91 and the exterior air source 92. The oxygen source 91 is the output of an oxygen generator which generates oxygen using heat recycled from the engine's exhaust. The exterior air source 92 is a pipe connected to a fan or an inlet from which the air outside of the vehicle can be conveyed into the adjustor 90. In implementation, the exterior air source 92 is coupled to the vehicle's ventilation system. The adjustor 90 is also coupled to a sensor of carbon dioxide 93 and a sensor of oxygen 94 which are installed in the interior of the vehicle. When carbon dioxide inside of the vehicle is higher than a certain amount, the carbon dioxide sensor 93 sends feedback messages to the adjustor 90. The adjustor 90 makes certain calculations and accordingly allows more exterior air in via the air output 96 and allows more oxygen in via the oxygen output 95. Similarly, if the oxygen inside of the vehicle is lower than a certain amount, the sensor 94 feedbacks to the adjustor 90, which, in turn, allows more exterior air and oxygen in. Like the carbon dioxide sensor 93, a sensor of carbon monoxide may also be installed. The humidity of the inside air can also be monitored by sensor and adjusted by the controller.

FIG. 16 is a schematic block diagram illustrating a vehicle air optimization (VAO) system according to the principle as illustrated in FIG. 15. The VAO system includes a number of hardware members and at least one software application. The hardware members include a tablet screen 100, a processor 101 associated with a database 102, and a controller 103 which executes the functions of the software application. The software application also supports a graphical user interface which is displayed on the tablet screen 100. The graphical user interface and the tablet screen 100 together constitute a “see and touch” interface, from which the user, usually the driver, may give operational commands, such as letting the VAO perform different tasks by touching different icons on the tablet screen 100. The processor 101, in response to the user's request sent via the “see and touch” interface, transforms the request into corresponding commands for the controller's execution. The controller 103 controls various mechanical and electrical devices according to the commands. The mechanical and electrical devices include an array of sensors 104 for detecting the air quality of the air inside the vehicle, a first array of switches 105 for controlling the inbound oxygen from the oxygen generator, and a second array of switches 106 for controlling the inbound air from outside or from the vehicle's ventilation system.

### The See-and-Touch Interface

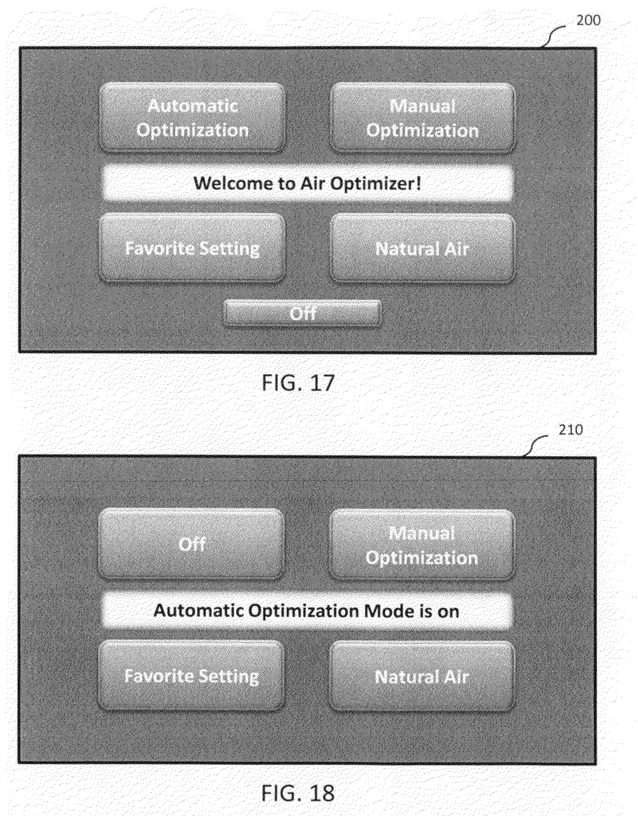

FIG. 17 is a schematic diagram illustrating the first see-and-touch screen 200, i.e., the “Main Menu” or “Home” of the interface. In a typical implementation, the main menu includes five icons, representing “Automatic Optimization”, “Manual Optimization”, “Favorite Setting”, “Natural Air”, and “Off” respectively. Other icons may be added in implementation. By touching any of the icons, the user will be returned a new screen. In one implementation, automatic optimization can be set as a default mode. If automatic optimization is not set as a default mode, the user needs to touch the “Automatic Optimization” icon to let the system enter the automatic optimization mode.

FIG. 18 is a schematic diagram illustrating the “Automatic Optimization” screen 210, which is returned to the user when the “Automatic Optimization” icon is touched. The screen 210 represents that the system enters the automatic optimization mode, i.e., the preset ideal mode of the air quality parameters. The screen 210 includes various option icons, such as “Manual Optimization”, “Natural Air”, “Favorite Setting”, “Off”, etc.

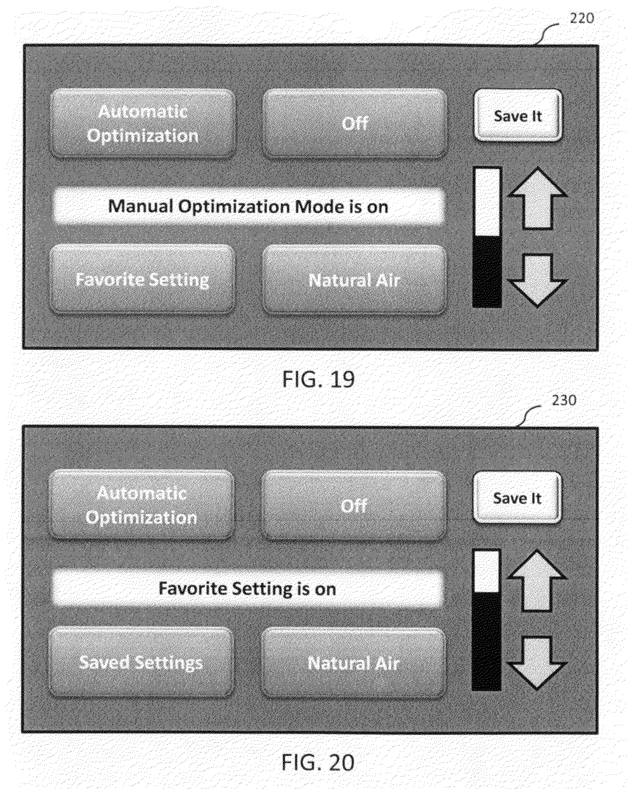

FIG. 19 is a schematic diagram illustrating the “Manual Optimization” screen 220, which is returned to the user when the “Manual Optimization” icon is touched. The screen 220 includes various option icons, such as “Automatic Optimization”, “Natural Air”, “Favorite Setting”, “Off”, an upward arrow for increasing, a downward arrow for decreasing, and an indication bar dynamically showing the manual adjustment level. The user may make adjustment on the oxygen v. air ratio within a preset range having a lowest limitation and a highest limitation. Optionally, the screen 220 may also include icons for “Save it”, etc. By touching the “Save it” icon, the setting is saved in a list of “saved settings” for future reference. The user can always appoint one save setting as the setting of “Favorite Setting”. In a typical implementation, the list of the saved settings may be up to 3.

FIG. 20 is a schematic diagram illustrating the “Favorite Setting” screen 230, which is returned to the user when the “Favorite Setting” icon is touched. The screen 230 includes various option icons, such as “Automatic Optimization”, “Natural Air”, “Saved Settings”, “Off”, an upward arrow for increasing, a downward arrow for decreasing, an indication bar dynamically showing the manual adjustment, and “Save it”. The user may make further adjustment on the oxygen v. air ratio within a preset range having a lowest limitation and a highest limitation. By touching the “Save it” icon, the new setting is saved in a list of “saved settings”. In a typical implementation, the list of saved settings may be up to 3.

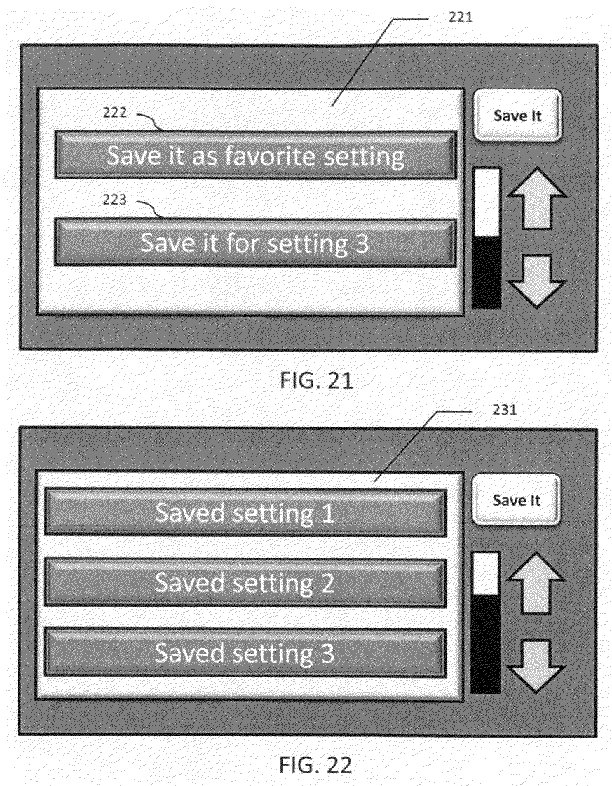

FIG. 21 is a schematic diagram illustrating a screen when the “Save It” icon is touched. It is the screen 220 in FIG. 19 overlaid by the pop-up window 221. The window 221 further includes an icon 222 for “Save It as Favorite Setting” and an icon 223 for “Save it for setting N”. When the icon 222 is touched, the user's setting overwrites any saved “favorite setting” and is saved as a new “favorite setting”. When the icon 223 is touched, the user's setting is saved. If there has been a saved setting, the new saved setting is named as “Saved Setting 2”; if there have been two saved settings, the new saved setting is named as “Saved Setting 3”. The number “N” in “Save Setting N” is dynamically updated by the processor. In a typical implementation, the list of the saved settings may be up to 3.

FIG. 22 is a schematic diagram illustrating a screen when the “Saved Settings” icon is touched. It is the screen 230 in FIG. 20 overlaid by the pop-up window 231. If there is no saved setting, the window 231 is blank, or it displays a message like “you have no saved settings”. If there are saved settings, the window 231 includes one or more icons, each of which represents a saved setting. When any of the icons is touched, the corresponding setting predominates. For example, when the “Saved setting 3” is touched, the most recent setting is on. Similarly, when the “Saved setting 1” is touched, the earliest setting is on. In this way, the driver may switch between different settings conveniently. Different driver may memorize her setting number and switches to her setting easily.

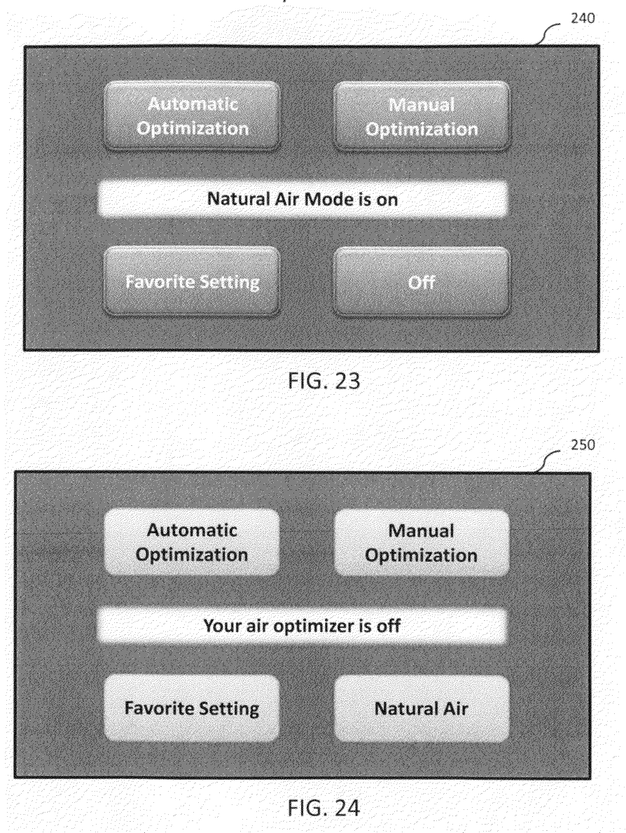

FIG. 23 is a schematic diagram illustrating the “Natural Air” screen 240, which is returned to the user when the “Natural Air” icon is touched. The screen 240 includes various option icons, such as “Automatic Optimization”, “Manual Optimization”, “Favorite Setting”, and “Off”, etc.

FIG. 24 is a schematic diagram illustrating the “Off” screen 250, which is returned to the user when the “Off” icon is touched. The screen 250 includes various option icons, such as “Automatic Optimization”, “Manual Optimization”, “My Favorite”, and “Regular Air”, etc., which are in diminished color. If anywhere of the “Off” screen 250 is touched, the “Air Optimizer” system is activated and the main menu as illustrated in FIG. 17 is returned.

Optionally, when “Off” icon is touched from any of the interface screens as illustrated above, the “Off” screen 250 comes and stays for 2-10 seconds. Then, the screen turns to dark, or the default interface, such as the GPS navigation system as illustrated below, predominates.

### Switching Between GPS Navigation and Air Optimizer

The air optimizer interface can be incorporated with the vehicle's GPS navigation (herein after as GPS) interface. On each screen of the GPS interface, there is an icon representing “Air Optimizer”. By touching the “Air Optimizer” icon, the air optimizer's “Main Menu” or “Home” is initiated. Similarly, on each screen of the air optimization interface, there is an icon representing GPS. By touching the GPS icon, the GPS interface is initiated.

The GPS interface may be set as default interface. When the “Air Optimizer” is off, the GPS interface predominates.

### The Voice Activation

The functions represented by the icons on the “see-and-touch” interface can be voice-activated. When an icon is touched, a stored voice message in the database is displayed. The following are a number of exemplary voice messages corresponding to the interface functions.

When screen 200 of FIG. 17 is initiated, the system displays the voice message: “Welcome to air optimizer.”

When “Automatic Optimization” icon is touched, the system displays the voice message: “The automatic optimization mode is on.”

When “Manual Optimization” icon is touched, the system displays the voice message: “The manual optimization mode is on. You may adjust the air by touching the arrows.”

When “Favorite Setting” icon is touched, the system displays the voice message: “Your favorite setting is on. You may change the setting by touching the arrows.”

When “Save It” icon is touched, the system displays the voice message: “Please make a choice.”

When “Save it as favorite setting” icon is touched, the system displays the voice message: “Your setting has been saved as favorite setting.”

When “Save it as setting 2” icon is touched, the system displays the voice message: “Your setting has been saved as setting number 2.”

When “Saved setting 3” icon is touched, the system displays the voice message: “Your most recent setting is on” or “Saved setting number 3 is on.”

When “Saved setting 1” icon is touched, the system displays the voice message: “Your earliest setting is on” or “Saved setting number 1 is on.”

When “Saved setting 2” icon is touched, the system displays the voice message: “Saved setting number 2 is on.”

When “Natural Air” icon is touched, the system displays the voice message: “You are enjoying natural air. No additional oxygen is added.”

When “Off” icon is touched, the system displays the voice message: “The air optimizer is off. Goodbye.”

### The Controller

The controller executes the commands represented by the icons. The parameters to be adjusted and controlled are the amounts of inbound oxygen and inbound air. The inbound air is from the vehicle's ventilation system. There are two ways to control the amount of the inbound oxygen-controlling the water feeding-in amount before the oxygen generator or controlling the oxygen feeding-in amount after the oxygen extractor. The preferred way is to control the water amount added to the splitter or decomposer of the oxygen generating system by electronically adjusting the valve on the water inlet pipe. The less water is added, the less oxygen is generated, and vice versa.

### The Database

The database 102 in FIG. 16 stores various categorized data, including but not limited to: the graphics for the “see and touch” interface, the voice messages, settings for inbound water, settings for inbound air, scales for each sensor, etc.

The database 102 can be a separate one or a part of the vehicle's existing database for the GPS navigation system.

While one or more embodiments of the present invention have been illustrated above, the skilled artisan will appreciate that modifications and adoptions to those embodiments may be made without departing from the scope and spirit of the present invention.

What is claimed is:

1. A system for optimizing the quality of a vehicle's inner air using gaseous oxygen which is generated using recycled heat from the exhaust of the vehicle's engine, comprising:
an oxygen generator, which generates oxygen by decomposing water using recycled heat from the vehicle's exhaust; and
an optimizer, which automatically adjusts oxygen amount added into the vehicle's inner air.

2. The system of claim 1, wherein the oxygen generator is mechanically coupled between the vehicle's engine and the vehicle's muffler.

3. The system of claim 1, wherein the oxygen generator comprises:
a first means to transform water into steam using recycled heat from the exhaust of the vehicle's engine;
a second means to transform the steam into gas comprising gaseous oxygen and gaseous hydrogen; and
a third means to extract the gaseous oxygen from the gas.

4. The system of claim 3, wherein the second means comprises at least one path, through which the steam passes from the first means into the third means, and wherein the at least one path's inner surface is coated with a catalyst which catalyzes dissociation of water molecules into gaseous oxygen and gaseous hydrogen.

5. The system of claim 3, wherein the second means comprises at least one honeycomb-like structure, the honeycomb-like structure having a number of paths, each path's inner surface being coated with a catalyst which catalyzes dissociation of water molecules into gaseous oxygen and gaseous hydrogen.

6. The system of claim 1, wherein the oxygen generator is mechanically coupled with the vehicle's muffler.

7. The system of claim 1, wherein the optimizer comprises at least one sensor for collecting data related to quality of the vehicle's interior air, an adjustor for adjusting the amount of input oxygen, and a controller coupled to the adjuster and a processor, wherein the processor is associated with a database and a tablet interface, and wherein a user may give operational command through the tablet interface.

8. A process for optimizing the quality of a vehicle's inner air using gaseous oxygen which is generated using recycled heat from the vehicle's exhaust, comprising:
providing a means to dissociate water using recycled heat from the vehicle's exhaust into gas comprising gaseous oxygen and gaseous hydrogen;
extracting oxygen from the gas;
adding oxygen into the vehicle's inner air;
wherein an optimizer is used to automatically adjust oxygen amount added into the vehicle's inner air.

9. The process of claim 8, wherein the dissociation means is mechanically coupled between the vehicle's engine and the vehicle's muffler.

10. The process of claim 8, wherein the dissociation means comprises:
means to transform water into hot steam using recycled heat from the vehicle's exhaust; and
at least one path, through which the hot steam passes through;
wherein the at least one path's inner surface is coated with a catalyst which catalyzes dissociation of water molecules into gaseous oxygen and gaseous hydrogen.

11. The process of claim 8, wherein the dissociation means comprises at least one honeycomb-like structure, the honeycomb-like structure having a number of paths, each path's inner surface being coated with a catalyst which catalyzes dissociation of water molecules into gaseous oxygen and gaseous hydrogen.

12. The process of claim 8, wherein the dissociation means is mechanically coupled with the vehicle's muffler.

13. The process of claim 8, wherein the optimizer comprises at least one sensor for collecting data related to quality of the vehicle's interior air, an adjustor for adjusting the amount of input oxygen, and a controller coupled to the adjustor and to a processor, wherein the processor is associated with a database and a tablet interface, and wherein a user may give operational command through the tablet interface.
